(19) United States
(12) Patent Application Publication
(10) Pub. No.: US 2021/0311214 A1
(43) Pub. Date: Oct. 7, 2021

(54) METHOD FOR DETECTING AND QUANTIFYING FRACTURE INTERACTION IN HYDRAULIC FRACTURING

(71) Applicant: CONOCOPHILLIPS COMPANY, Houston, TX (US)

(72) Inventor: Samik SIL, Katy, TX (US)

(73) Assignee: CONOCOPHILLIPS COMPANY, Houston, TX (US)

(21) Appl. No.: 14/177,972

(22) Filed: Feb. 11, 2014

Related U.S. Application Data
(60) Provisional application No. 61/763,083, filed on Feb. 11, 2013.

(51) Int. Cl. G01V 1/30; G01V 1/28; E21B 43/26; E21B 49/00

(52) U.S. Cl. CPC G01V 1/30; G01V 1/288; G01V 2210/60; E21B 49/00; G01V 2210/1216; E21B 43/26

(57) ABSTRACT

Using microseismic analysis to identify and quantify the hydraulic fracture interaction in the Earth formation. Identification of the interaction is based on the magnitude of the events and therefore independent of the location uncertainty. Quantification of the interaction is location based.

### CROSS-REFERENCE TO RELATED APPLICATIONS

This application is a non-provisional application which claims benefit under 35 USC § 119(e) to U.S. Provisional Application Ser. No. 61/763,083 filed 11 Feb. 2013, entitled “METHOD FOR DETECTING AND QUANTIFYING FRACTURE INTERACTION IN HYDRAULIC FRACTURING,” which is incorporated herein in its entirety.

### FIELD OF THE INVENTION

The present invention relates generally to the field of microseismic analysis of Earth formations. More specifically, but not by way of limitation, embodiments of the present invention relate to using microseismic analysis to identify and quantify the fracture interaction in the Earth formation.

### BACKGROUND OF THE INVENTION

Microseismic measurements can be characterized as a variant of seismics. In conventional seismic explorations a seismic source placed at a predetermined location is activated and generates sufficient acoustic energy to cause acoustic waves to travel through the Earth. Reflected or refracted parts of this energy are then recorded by seismic receivers such as hydrophones and geophones.

In passive seismic or microseismic monitoring there is no actively controlled and triggered seismic source at a known location. The seismic energy is generated through so-called microseismic events caused by subterranean shifts and changes that at least partially give rise to acoustic waves which in turn can be recorded using suitable receivers. Although the microseismic events may be a consequence of human activity disturbing the subterranean rock, they are quite different from operation of equipment provided as an active seismic source.

A specific field within the area of passive seismic monitoring is the monitoring of hydraulic fracturing. Such a hydraulic fracturing operation includes pumping large amounts of fluid downhole to induce cracks in the Earth, thereby creating pathways by which oil and/or gas may flow. After a crack is generated, sand or some other proppant material is commonly injected into the crack to prevent it from closing completely when pumping stops. The proppant particles placed within the newly formed fracture keep it open as a conductive pathway for oil and/or gas to flow into the wellbore. In the hydrocarbon industry, hydraulic fracturing of a hydrocarbon reservoir may be referred to as “stimulation” as the intent is to stimulate the production of the hydrocarbons.

In the field of microseismic monitoring the acoustic signals generated in the course of a fracturing operation are treated as microseismic events. However, use is made of the information available from the fracturing operation, such as timing and pressure.

Microseismic monitoring of hydraulic fracturing is a relatively recent, but established technology. In general, such monitoring is performed using a set of geophones located in a vertical well in the proximity of the hydraulic fracturing. Uses of surface geophone array and shallow buried geophones are also common practice.

In microseismic monitoring, a hydraulic fracture is created down a borehole and data received from geophones, hydrophones and/or other sensors is processed. Typically the sensors are used to record microseismic wavefields generated by the hydraulic fracturing. By inverting the obtained microseismic wavefields, locations of microseismic events may be determined as well as uncertainties for determined locations, source mechanisms and/or the like. The set of event locations and the corresponding uncertainties is known as the microseismic event cloud.

In general, the microseismic monitoring is used so that an understanding of the location and size of the fracture can be ascertained. The spread of the fracture through an Earth formation may also be monitored. This data may be used to help manage the fracturing of the Earth formation for hydrocarbon production or the like and for interpretation/projection of hydrocarbon production through the hydraulically fractured Earth formation.

Current microseismic techniques for determining fracture interaction (between two induced fractures or between an existing and induced fracture) are based on stress simulation and analysis. (See Roussel et al., 2011 and Daneshy et al., 2012). Other techniques include use of microseismic data to show interaction between fractures from different stages (visually) and use of a reservoir simulation models to predict better stage spacing. (See Quirk, D., et al., 2010). However, the problem with visual interpretation of fracture interaction is that the microseismic event may contain spatial location uncertainty.

Therefore, a need exists for a method of detecting and quantifying fracture interaction, which depends on a more basic property, i.e., magnitude of the event.

### SUMMARY OF THE INVENTION

In an embodiment, a method for detecting a fracture interaction in a well located within a subterranean Earth formation includes: identifying at least two consecutive stage, wherein each stage includes at least 50 microseismic events; calculating a b-value using all or a group of microseismic events for each stage; and detecting fracture interaction when observing a combination decrease in b value from one stage to the next stage and a b value tending or equal to 1.

In another embodiment, a method for determining a fracture interaction percentage in an Earth formation includes: identifying at least two consecutive stages in the Earth formation, a stage and a prior stage(s), wherein the prior stage(s) precedes the stage, wherein each stage includes at least one microseismic event; plotting a single microseismic event from the stage against all of the microseismic events from the prior stage; assigning a value to the single microseismic event, wherein the value is determined by observing the plot wherein if the single microseismic event is within a search radius of any of the microseismic events in the prior stage, the value for the single microseismic event is 1 otherwise the value is 0, wherein the search radius is either constant or based on the magnitude range of events; repeating steps (b) and (c) until all microseismic events in the stage have assigned values; and summing all the values from the stage then dividing by the total number of seismic events in the stage and multiplying by 100.

### BRIEF DESCRIPTION OF THE DRAWINGS

The invention, together with further advantages thereof, may best be understood by reference to the following description taken in conjunction with the accompanying drawings in which:

FIG. 1 is a plot of b values versus stage sequence number in accord with an embodiment of the present invention.

FIG. 2 is a map view of the detected microseismic events in accord with an embodiment of the present invention.

FIG. 3 is a map view of detected microseismic events in accord with an embodiment of the present invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used in another embodiment to yield a still further embodiment. Thus, it is intended that the present invention cover such modifications and variations that come within the scope of the appended claims and their equivalents.

The embodiments and methods described herein, have application to both horizontal and/or vertical wells. As used herein, a “microseismic event” or “induced fracturing events” is an occurrence in which energy is briefly released in the Earth's crust (or Earth formation), resulting in a series of seismic waves which move through the crust. In some cases, the energy can be intense enough that it is felt in the form of an earthquake, while in other microseismic events, the energy is so mild that it can only be identified with specialized equipment. Example of source of microseismic events includes hydraulic fracturing.

As used herein, a “b value” is a measure of the relative number of small to large seismic events that occur in a given area in a given time period. In particular, the b value is the slope of the frequency-magnitude distribution (Ishimoto et al., 1939; Gutenberg et al., 1944) for a given population of microseismic events. Studies have shown that the b-value changes with material heterogeneity (Mogi, 1962), thermal gradient (Warren et al., 1970), and applied stress (Scholz, 1968; Wyss, 1973; Urbancic et al., 1992; Schorlemmer et al., 2004; Schorlemmer et al., 2005). In the following equation (1)

log₁₀ N_{M}=a−bM (1)

where M is the magnitude of events, N_{M} is the cumulative number of earthquakes or events with magnitudes greater than or equal to M. According to equation (1), logarithms of the cumulative number of events (N_{M}) follow a linear relationship to the magnitude of events(M), where a is the intercept and b is the slope of that linear relationship. Determination of the slope value using equation 1 (or a different form of equation) for a group of microseismic events is termed as b value analysis.

The b value estimation arose from classical earthquake seismology. This b value estimation relies on the fact that the frequency of an event in any earthquake sequence and the magnitude of the event are not random; rather, they follow a power-law relationship. Typically, for a tectonic earthquake the b value is around 1. (See Farrell et al., 2009). Variations in the b value can be attributed to the materials heterogeneity (for hydraulic fracturing it is reservoir heterogeneity), thermal gradient, applied stress, and other factors. (See Farrell et al., 2009).

Similarly, power-law relationships exist between the number of induced fracturing events and their magnitudes for induced fracturing. (Scholz, 1968). When uniform pressure is applied to every stage and medium in considerably homogeneous, then the observed b value for each stage should be about 2 or more for every stage. However, if a sudden decrease in the b value is observed from one stage to the next stage and the b value is about 1, then a fault or fracture (or a pre-existing weak point) may be present. This property is utilized to detect the fracture interaction between two consecutive stages located within a well within the subterranean Earth formation.

To detect the fracture interaction between two consecutive stages, the b value can be calculated for all of the microseismic events (for each stage) using equation (1) considering the magnitude and frequency distribution of the microseismic events from those stages. Next, all of the b values for each stage can be plotted.

Some embodiments provide a method for detecting a hydraulic fracture interaction in a well located within a subterranean formation comprising: inducing a fracture in the subterranean formation; measuring physical characteristic of a plurality of microseismic events, wherein the plurality of microseismic events are partitioned into at least two consecutive stages; calculating a b-value via a computer processing system using the physical characteristic of the plurality of microseismic events for each stage; and detecting fracture interaction when observing a combination decrease in b value from one stage to the next stage and a b value tending or equal to 1. In some embodiments, the fracture is induced via hydraulic fracturing. Each stage of the at least two consecutive stages may include 50 or more microseismic events. The b-value may be calculated using all or a subgroup of microseismic events for each stage. Examples of physical characteristic are selected from the group consisting of: magnitude, frequency distribution, or both.

Some embodiments provide a method for determining a fracture interaction percentage in a subterranean formation undergoing hydraulic fracturing comprising: identifying at least two consecutive stages defined as a later stage and a prior stage, wherein each stage includes at least one microseismic event; plotting via a computer processing system a single microseismic event from the later stage against all of the microseismic events from the prior stage; assigning a value to the single microseismic event, wherein the value is determined by observing the plot wherein if the single microseismic event is within a search radius of any of the microseismic events in the prior stage, the value for the single microseismic event is 1 otherwise the value is 0, wherein the search radius is either constant or based on the magnitude range of events; repeating steps (b) and (c) until all microseismic events in the stage have assigned values; and summing via a computer processing system all the values from the stage then dividing by the total number of seismic events in the stage and multiplying by 100.

### Example

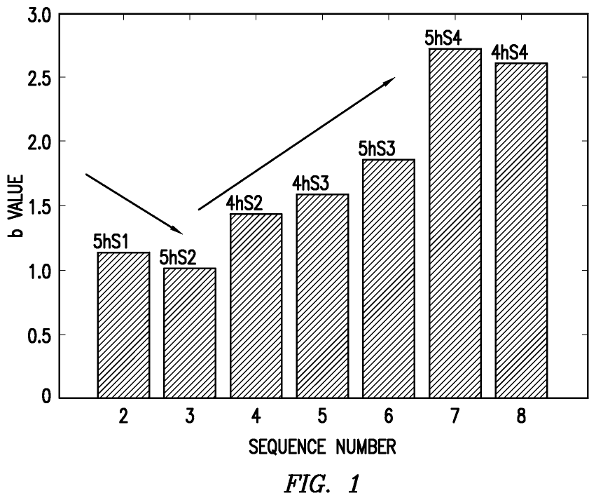

FIG. 1 shows an example of a plot of b values from two horizontal wells (labeled “4h” and “5h”) at each stage. The nomenclature in FIG. 1 refers to the well number (h) and the stage number (S). For example 5hS1 refers to horizontal well 5 at stage 1. Each horizontal well can include numerous stages.

As shown in FIG. 1, a decline in b value is observed at stage 5hS2 from previous stage 5hS1. The b value for stage 5hS2 is around 1, indicating interaction of induced fractures with a pre-existing fractures (or weak point). Since the medium is homogeneous, these pre-existing fractures may come only from the previous stages. Thus, microseismic events generated in this stage (5hS2) may be interacting with microseismic events from the previous stages (5hS1).

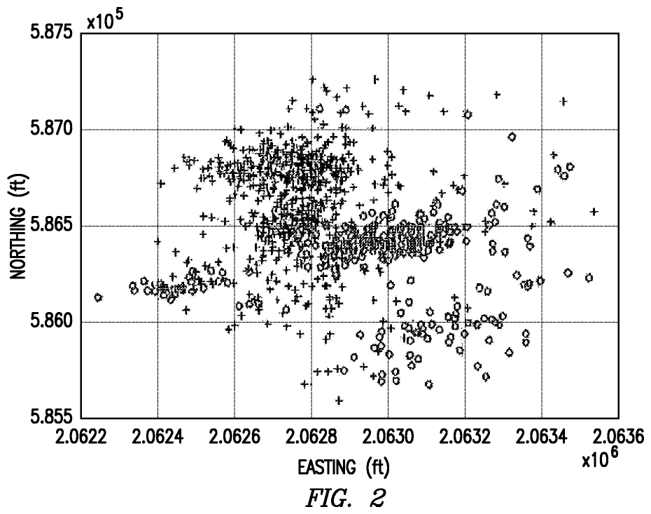

FIG. 2 is a map view of the located microseismic events in 5hS2 stage (circle) and the previous stage 5hS1 (cross). The microseismic events that are spatially overlapping indicate considerable interaction.

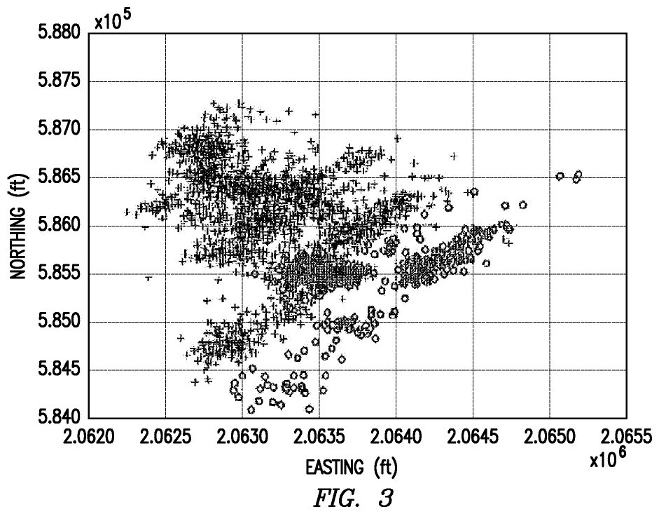

FIG. 3 is a map of located microseismic events in 4hS4 (circle) and all the previous stages (cross). FIG. 1 shows a more expected b value for hydraulic fracturing (around 2) for the stage 4hS4. The interaction of the events from this stage should be minimal with its prior stages. FIG. 3 indicates that most of the microseismic events from stage 4hS4 fall in a new area (circle).

To quantify the fracture interaction percentage between two consecutive stages, a stage and a prior stage, with at least one microseismic event in each stage within the Earth's formation, a single microseismic event from the stage is plotted against all of the microseismic events from the prior stage. Next, an interaction percentage value is assigned to that single microseismic event. The value is determined by observing the plot to determine whether the single microseismic event is within a search radius of any of the microseismic events in the prior stage. If it is observed that the single microseismic event is within the search radius, then the value for the single microseismic event is 1 otherwise the value is 0. The search radius can be fixed or variable (based on the magnitude of the concerned events). Similarly a value is assigned to every microseismic event in the stage using the search radius process. All of the values are then added together, divided by the total number of microseismic events in the stage and multiplied by 100. This returns the interaction percentage of the events from one stage with its prior stages.

For example, consider a stage C with some microseismic events, where A and B are the prio stages. Let's assume that stage C has five (5) microseismic events. Consider one event from stage C. The search radius is two (2) meters for the event of stage C. This search radius is based on the maximum radius of the seismic events observed as one (1) meter, but can be modified based on the range of magnitude of the events in the considered stages. If at least one event from stages A and/or B falls within the search radius from the single event of stage C, then the assigned value is 1 for the singe event of stage C. Otherwise, no events from stages A and/or B fall within the search radius of the single event C, then the assigned value is 0 for the single event. Then consider the next event of stage C, perform a similar search, and assign a value of 0 or 1 based on the presence of microseismic events from prior stages (A and B) within the specified search radius. All of the seismic events from stage C are assigned a value. All of the values are added together. The sum is then divided by the total number of seismic events from stage C. The obtained value is then multiplied by 100 to provide the interaction in a percent.

Suppose, for example, all five (5) seismic events from stage C are within the search radius of microseismic events of prior stages A and/or B. Thus, each of the microseismic events has assigned values of one (1). The sum of those values is five (5). Divide the sum by the total number of seismic events in stage C, i.e., 5. The total, i.e., 1, is then multiplied by 100. This suggests that stage C has 100% interaction with its prior stages (A and B). Similarly, if none of the seismic events from stage C finds any events from stages A and/or B within the specified search radius, then their summed value is zero (0). Therefore, stage C has 0% interaction with its prior stages (A and B).

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. Daneshy, A. et al., “Fracture Shadowing: A Direct Method for Determining of the Reach and Propagation Pattern of Hydraulic Fractures in Horizontal Wells,” SPE, 2012.
2. Farrell, J., et al. “Earthquake swarm and b-value characterization of the Yellowstone volcano-tectonic system,” journal of Volcanology and Geothermal Research 188 (2009) 260-276.
3. Gutenberg, B. et al., 1944. Frequency of earthquakes in California. Bull. Seismol. Soc. Am. 34, 185-188.
4. Ishimoto, M. et al., “Observations of earthquakes registered with the micoseismograph constructed recently,” Bull. Earthq. Res. Inst. Univ. Tokyo 17, 443-478 (1939).
5. Mogi, K., 1962. Magnitude-frequency relation for elastic shocks accompanying fractures of various materials and some related problems in earthquakes. Bull. Earthq. Res. Inst. Univ. Tokyo 40, 831-853.
6. Quirk, D. et al., 2010. Integration of Montney Microseismic Information into a Reservoir Simulator to Analyze a Horizontal Wellbore with Multiple Fracture Stages,” Soc. Petrol. Eng.
7. Roussel, N., et al., “Optimizing Fracture Spacing and Sequencing in Horizontal-Well Fracturing,” SPE Production & Operations, 2011.
8. Scholz, C. H., 1968. The Frequency-Magnitude Relation of Microfracturing in Rock and its Relation to Earthquakes. Bull. Seismol. Soc. Am., 58(1), 399-426.
9. Schorlemmer, D. et al., 2005. Microseismicity data forecast rupture area. Nature 434, 1086.
10. Schorlemmer, D. et al., 2005. Variations in earthquake-size distribution across different stress regimes. Nature 437, 539-542.
11. Urbancic, T. I., et al., 1992. Space-time correlations of b values with stress release. Pure Appl. Geophys. 139, 449-462.
12. Warren, N. W. et al., 1970. An experimental study of thermally induced microfracturing and its relation to volcanic seismicity. J. Geophys. Res. 75, 4455-4464.
13. Wessels, S., et al., 2011. Identifying fault activation during hydraulic stimulation in the Barnett shale: source mechanisms, b values and energy release analyses of microseismicity. Soc. Exploration Geophysicists.
14. Wyss, M., 1973. Towards a physical understanding of the earthquake frequency distribution. Geophys. J. R. Astron. Soc. 31, 341.

1. A method for detecting a hydraulic fracture interaction in a well located within a subterranean formation comprising:
a) inducing a fracture in the subterranean formation;
b) measuring physical characteristic of a plurality of microseismic events, wherein the plurality of microseismic events are partitioned into at least two consecutive stages;
c) calculating a b-value via a computer processing system using the physical characteristic of the plurality of microseismic events for each stage; and
d) detecting fracture interaction when observing a combination decrease in b value from one stage to the next stage and a b value tending or equal to 1.

2. The method of claim 1, wherein the fracture is induced via hydraulic fracturing.

3. The method of claim 1, wherein each stage of the at least two consecutive stages includes at least 50 microseismic events.

4. The method of claim 1, wherein the b-value is calculated using all or a subgroup of microseismic events for each stage.

5. The method of claim 1, wherein the physical characteristic is selected from the group consisting of: magnitude, frequency distribution, or both.

6. A method for determining a fracture interaction percentage in a subterranean formation undergoing hydraulic fracturing comprising:
a) identifying at least two consecutive stages defined as a later stage and a prior stage, wherein each stage includes at least one microseismic event;
b) plotting via a computer processing system a single microseismic event from the later stage against all of the microseismic events from the prior stage;
c) assigning a value to the single microseismic event, wherein the value is determined by observing the plot wherein if the single microseismic event is within a search radius of any of the microseismic events in the prior stage, the value for the single microseismic event is 1 otherwise the value is 0, wherein the search radius is either constant or based on the magnitude range of events;
d) repeating steps (b) and (c) until all microseismic events in the stage have assigned values; and
e) summing via a computer processing system all the values from the stage then dividing by the total number of seismic events in the stage and multiplying by 100.
